(19) United States
(12) Patent Application Publication
(10) Pub. No.: US 2006/0126940 A1
(43) Pub. Date: Jun. 15, 2006

(54) Apparatus and method for detecting eye position

(75) Inventors: Jungbae Kim, Yongin-si (KR); Chanmin Park, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/294,468

(22) Filed: Dec. 6, 2005

(30) Foreign Application Priority Data
Dec. 15, 2004 (KR) 10-2004-0106572

(51) Int. Cl. G06K 9/46

(52) U.S. Cl. 382/190

(57) ABSTRACT

A method of detecting an eye position in a face image, and an apparatus to use the method, the method including detecting eye candidates in eye regions normalized to a predetermined size from the face image; detecting an eye pair candidate from the detected eye candidates; and determining the eye position from the detected eye pair candidate.

### CROSS-REFERENCE TO RELATED APPLICATIONS

This application claims the benefit of Korean Patent Application No. 10-2004-0106572, filed on Dec. 15, 2004, in the Korean Intellectual Property Office, the disclosure of which is incorporated herein by reference.

### BACKGROUND OF THE INVENTION

1. Field of the Invention

The present invention relates to a method of detecting an eye position and an apparatus to perform the method, and, more particularly, to a method of detecting an eye position, and an apparatus to perform the method, which includes detecting eye candidates in a face image, detecting an eye pair candidate among combinations of eye pair candidates generated from the detected eye candidates, and determining an eye position from the detected eye pair candidate.

2. Description of the Related Art

Face detection technology is becoming more important as it is applied to various technology fields such as face recognition technology, human computer interfaces, video monitoring systems, and image searching technology using a face image. Since the size and position of a face are generally normalized for face recognition by the position of its eyes, eye detection technology is essential for face recognition.

Korean Patent Application No. 10-2001-0080719 discloses an eye detection method which generates an eye pair candidate in a face image according to a binarized threshold value determined through a binary search, and then determines an eye pair through a template matching operation performed in relation to the generated eye pair candidate. However, such a method has a drawback in that there is a low probability of eyes actually existing among the binarized eye pair candidate.

Meanwhile, Korean Patent Application No. 10-2001-0046110 discloses an eye detection method which detects eye candidates through template matching with respect to an “average eye image”, generates a face image from the detected eye candidates, and finally determines an eye pair by comparing the generated face image with an average face image. However, such a method has a problem in that only limited types of faces and eyes may be detected using the average face and eye images.

### SUMMARY OF THE INVENTION

The present invention provides an eye position detection method capable of accurately detecting an eye position in a face image.

The present invention also provides an eye position detection apparatus capable of accurately detecting an eye position in a face image.

The present invention also provides a training apparatus to detect an eye position in a face image.

The present invention also provides a training apparatus to detect an eye pair position in a face image.

The present invention also provides a training method of detecting an eye position in a face image.

The present invention also provides a training method of detecting an eye pair position in a face image.

Additional aspects and/or advantages of the invention will be set forth in part in the description which follows and, in part, will be apparent from the description, or may be learned by practice of the invention.

According to an aspect of the present invention, there is provided a method of detecting an eye position in a face image, the method including: detecting eye candidates in eye regions normalized to a predetermined size from the face image; detecting an eye pair candidate from the detected eye candidates; and determining the eye position from the detected eye pair candidate. The method may further include normalizing a right eye region and a left eye region in the face image to a first size prior to detecting the eye candidate.

Detecting the eye candidate may include: dividing an eye region normalized to a first size into sub-windows of a second size which is smaller than the first size; normalizing the sub-windows of the second size to a third size; extracting an eye feature from the normalized sub-windows of the third size; detecting sub-windows of the extracted eye feature as eye candidates by training a training DB storing an eye image of the third size, and by using a cascade eye detector generated according to eye features selected from the eye image training result; and combining overlapping eye candidates into an average size and position.

Detecting the eye pair candidate from the detected eye candidate may include: generating an eye pair from combinations of the detected eye candidates, normalizing the generated eye pair to a predetermined size, and extracting an eye pair feature from the normalized eye pair; and detecting the eye pair as the eye pair candidate by training an eye pair training DB, and by using a cascade eye pair detector generated according to eye pair features selected from the eye pair training result.

An eye pair candidate having a largest feature value among the detected eye pair candidates may be determined as an eye pair in determining the eye position from the detected eye pair candidate, according to a highest process level number of the cascade eye pair detector for the detected eye pair candidate, a number of combined eye candidates, and a difference between a left eye position and a right eye position of the eye pair candidate.

According to another aspect of the present invention, there is provided an apparatus to detect an eye position in a face image, the apparatus including: an eye candidate detector which detects eye candidates in eye regions normalized to a predetermined size from the face image; an eye pair candidate detector which detects an eye pair candidate from the detected eye candidates; and an eye position determiner which determines the eye position from the detected eye pair candidate.

The apparatus may further include an eye region limiter which limits and normalizes a right eye region and a left eye region in the face image to a first size.

The eye candidate detector may include: a region divider which divides an eye region normalized to a first size into sub-windows of a second size which is smaller than the first size; a normalizer which normalizes the sub-windows of the second size to a third size; a feature extractor which extracts an eye feature from the normalized sub-windows of the third size; a cascade eye detector which trains an eye image training DB, selects eye features from the eye image training result, and detects whether the extracted eye feature accords with the selected eye features; a detector which detects a sub-window of an eye feature which reaches a highest level of the cascade eye detector as an eye candidate; and a combiner combining overlapping eye candidates out of the detected eye candidates into an average size and position.

The eye pair candidate detector may include: a feature extractor which extracts an eye pair feature from an eye pair generated from combinations of the detected eye candidates; a cascade eye pair detector which trains an eye pair training DB, selects eye pair features from the eye pair training result, and detects whether the extracted eye pair feature accords with the selected eye pair features; and a detector which detects a combination of an eye pair which reaches the highest level of the cascade eye pair detector as an eye pair candidate.

The eye position determiner may include: a calculator which calculates a position difference between a left eye and a right eye of the detected eye pair candidate; and a determiner which determines an eye pair according to a highest process level number of a cascade eye pair detector for the detected eye pair candidate, a number of combined eye candidates, and a calculated position difference.

According to another aspect of the present invention, there is provided a training device to make a detector to detect an eye in an eye image, the device including: a memory which stores an eye image training DB; a feature selector which trains the eye image training DB by normalizing an eye image of the eye image training DB to a predetermined size, and selects an eye feature to be extracted according to the eye image training result; a mirror feature generator which generates a mirror feature by exchanging left and right coordinates of the selected eye feature; and a making unit which makes the detector according to the selected eye feature or the generated mirror feature.

According to another aspect of the present invention, there is provided a training device to make a detector to detect an eye pair in an eye pair image, the device including: a memory which stores an eye pair training DB; a feature selector which trains the eye image training DB by normalizing an eye pair image of the eye pair training DB to a predetermined size, and selects an eye pair feature to be extracted according to the eye pair training result; and a making unit which makes the detector according to the selected eye pair feature, wherein the eye pair image used in the eye pair training DB is normalized to have a width-to-height ratio of 3:1.

According to another aspect of the present invention, there is provided a training method used to make a detector to detect an eye in an eye image, the method including: training an eye image training DB by normalizing an eye image of the eye image training DB to a predetermined size; selecting an eye feature to be extracted according to the eye image training result; generating a mirror feature by exchanging left and right coordinates of the selected eye feature; and making the detector according to the selected eye feature or the generated mirror feature.

According to another aspect of the present invention, there is provided a training method used to make a detector to detect an eye pair in an eye pair image, the method including: training an eye pair training DB by normalizing an eye pair image of the eye pair training DB to a predetermined size; selecting an eye pair feature to be extracted according to the eye pair image training result; and making the detector according to the selected eye pair feature, wherein the eye pair image used in the eye pair training DB is normalized to have a width-to-height ratio of 3:1.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a block diagram of an eye position detection apparatus according to an embodiment of the present invention;

FIG. 2 illustrates an example of an eye candidate region limited to a first size in a face image;

FIG. 3 illustrates a block diagram of an eye candidate detector according to an embodiment of the present invention;

FIG. 4 illustrates a block diagram of an eye image training device according to an embodiment of the present invention;

FIG. 5 illustrates types of eye images used in an eye image training DB of the eye image training device of FIG. 4;

FIG. 6 illustrates a block diagram of a first detector of the eye candidate detector according to an embodiment of the present invention;

FIG. 7 illustrates a block diagram of an eye pair candidate detector according to an embodiment of the present invention;

FIG. 8 illustrates a block diagram of an eye pair training device according to an embodiment of the present invention;

FIG. 9 illustrates an eye pair image reconstructed by an eye pair reconstructor according to an embodiment of the present invention;

FIG. 10 illustrates a block diagram of an eye position determiner according to an embodiment of the present invention;

FIG. 11 is a flow chart illustrating an eye position detection method according to an embodiment of the present invention;

FIG. 12 is a flow chart illustrating an eye candidate detection method according to an embodiment of the present invention;

FIG. 13 is a detailed flow chart illustrating a method of detecting an eye pair candidate from combinations of detected eye candidates according to an embodiment of the present invention;

FIG. 14 is a flow chart illustrating an eye image training method according to an embodiment of the present invention; and

FIG. 15 is a flow chart illustrating an eye pair training method according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

FIG. 1 illustrates a block diagram of an eye position detection apparatus according to an embodiment of the present invention.

Referring to FIG. 1, the eye position detection apparatus includes an eye region limiter 110, an eye candidate detector 120, an eye pair candidate detector 130, and an eye position determiner 140.

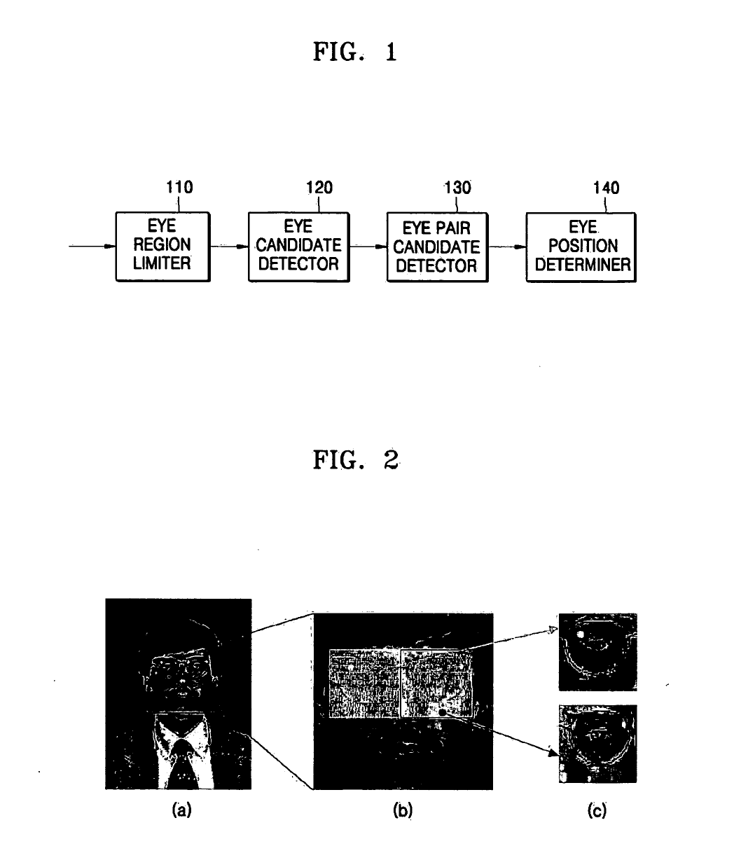

The eye region limiter normalizes a left eye region and a right eye region of a front face image to a first size. For example, the left and right eye regions may be limited within the ranges of approximately 10% through 50% and 50% through 90% in the x-axis direction, and within the range of approximately 10% through 50% in the y-axis direction. The limited eye regions is normalized to the first size, for example, 50×50 pixels, as illustrated in FIG. 2, which illustrates an example of an eye candidate region normalized to a first size in a face image.

The eye candidate detector 120 divides the normalized 50×50 pixel eye regions of the first size into sub-windows of a second size larger than 14×14 pixels, for example, and then normalizes those divided sub-windows to a third size (for example, 14×14 pixels). The eye candidate detector 120 detects eye candidates in the normalized eye regions using eye features selected through the training of an eye image DB and a cascade eye detector generated on the basis of the selected eye features.

The eye pair candidate detector 130 detects eye pair candidates from a combination of the detected eye candidates using eye pair features selected through the training of an eye pair image DB and a cascade eye pair detector generated on the basis of the selected eye pair features, since the detected eye candidate may be an unwanted image, such as an eyebrow or an eyeglass frame, instead of an actual eye.

The eye position determiner 140 determines one eye pair out of the detected eye pair candidates from a feature value “x” used to determine an eye pair. The determined eye pair corresponds to both eye positions.

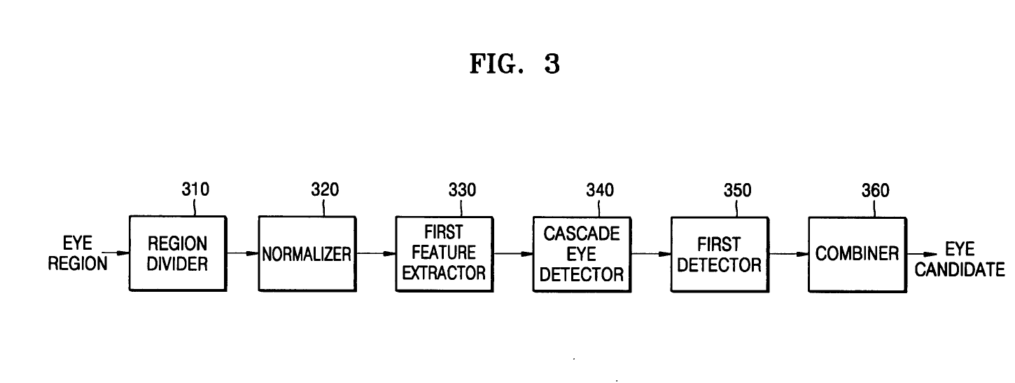

FIG. 3 illustrates a block diagram of an eye candidate detector according to an embodiment of the present invention.

Referring to FIG. 3, the eye candidate detector includes a region divider 310, a normalizer 320, a first feature extractor 330, a cascade eye detector 340, a first detector 350, and a combiner 360.

The region divider 310 divides an eye region, which is received from the eye region limiter 110, into regions of a predetermined size. For example, when receiving a 50×50 pixel eye region from the eye region limiter 110, the region divider 310 divides the received eye region into sub-windows smaller than the first size of 50×50 pixels, and larger than 14×14 pixels. The region divider 310 divides the received eye region of the first size while enlarging the second size of the sub-window by a predetermined factor (for example, by 1.2 times), up to the first size. The normalizer 320 normalizes the divided sub-window to the third size (for example, 14×14 pixels).

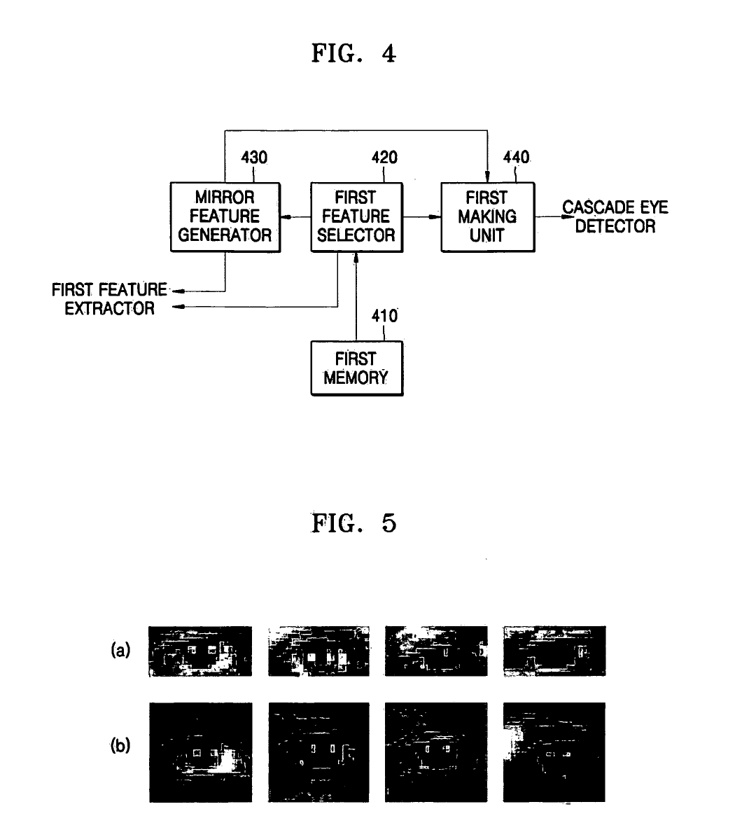

The first feature extractor 330 extracts from the normalized sub-window an eye feature corresponding to a mirror feature, or an eye feature selected by an eye training device. The eye training device trains an eye training DB and generates a cascade eye detector on the basis of the eye feature selected from the eye training result. The eye training device may be generated in an offline state and then used in the eye candidate detector. The eye training device will be described in detail later with reference to FIG. 4. The cascade eye detector 340 detects whether the extracted eye feature from the cascade detector corresponds to the selected eye features.

The first detector 350 detects a sub-window corresponding to an eye feature which proceeds to the highest level of the cascade eye detector 340 as an eye candidate. The cascade eye detector 340 comprises a plurality of detectors to detect a combination of eye features, connected in a cascade. The cascade eye detector 340 detects the extracted eye features through the detectors, and the first detector 350 detects a sub-window corresponding to an eye feature which proceeds to the highest level (that is, the most detectors) of the cascade eye detector 340 as an eye candidate.

The combiner 360 combines overlapping eye candidates into one eye candidate having the average size and position of the combined eye candidates.

FIG. 4 illustrates a block diagram of an eye training device according to an embodiment of the present invention.

Referring to FIG. 4, the eye training device includes a first memory 410, a first feature selector 420, a mirror feature generator 430, and a first making unit 440.

The first memory 410 stores an eye training DB containing a plurality of eye images. The first feature selector 420 trains the eye training DB by normalizing an eye image of the eye training DB to a predetermined size, and selects an eye feature to be extracted on the basis of the eye training result. Preferably, though not necessarily, the first feature selector selects an eye feature through an appearance-based pattern recognition method. The appearance-based pattern recognition method is a method that recognizes an eye through templates trained by a training DB, such as the color, shape, and position of an eye.

Preferably, though not necessarily, the first feature selector 420 is trained using an Adaboost algorithm. Preferably, though not necessarily, the size of an eye image stored in the eye training DB is normalized to the third size (for example, 14×14 pixels) having a width-to-height ratio of 1:1. The third size is the size of an eye image normalized to train the eye training device, and is also the lower size limit of the sub-window divided by the region divider 310.

The mirror feature generator 430 generates a mirror feature by exchanging left and right coordinates of the selected eye feature. In this embodiment, a DB for left and/or right eyes is stored in the first memory 410, and an eye feature extracted through the training of one of the left or right eye is selected by the first feature selector 420. An eye feature for the remaining eye is generated through a mirror feature of the already-selected eye feature. The mirror feature is a feature of the remaining eye (for example, a right eye) generated by exchanging left and right coordinates of a feature of the selected eye (for example, a left eye).

The first making unit 440 makes a detector to detect an eye candidate from an eye image of a face image input to the eye position detecting apparatus on the basis of the selected eye feature or the generated mirror feature. Preferably, though not necessarily, the detector made by the first making unit 440 is a cascade detector having a cascade structure of detectors to detect a combination of the eye features selected by the first feature selector 420.

FIG. 5 illustrates examples of a few types of eye images used in an eye image training DB of the eye image training device. In detail, FIG. 5(a) illustrates an eye image having a width-to-height ratio of 2:1, which contains only eye data. FIG. 5(b) illustrates an eye image having a width-to-height ratio of 1:1, which contains upper and lower peripheral data as well as eye data. In this embodiment, the eye training device trains an eye image DB storing an eye image with a width-to-height ratio of 1:1, selects an eye feature to be extracted, and makes a cascade eye detector on the basis of the selected eye feature.

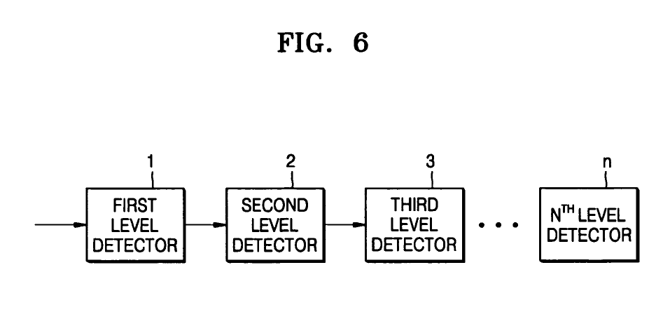

FIG. 6 illustrates a block diagram of a cascade eye detector to detect an eye candidate according to an embodiment of the present invention.

Referring to FIG. 6, the cascade eye detector has a cascade connection structure of a plurality of level detectors to detect a combination of eye features selected from the eye training result. The level detectors 1 through N each detect a weighted sum of eye feature values extracted by the first feature extractor 330, using a threshold value. Since a sub-window of an eye feature satisfying the highest level of the cascade eye detector is detected as an eye candidate, a number of eye candidates are detected by the cascade eye detector. For example, if it is assumed that the final level of the cascade eye detector is “N”, a sub-window of an eye feature satisfying a highest level “M,” but not satisfying the final level “N,” is detected as an eye candidate.

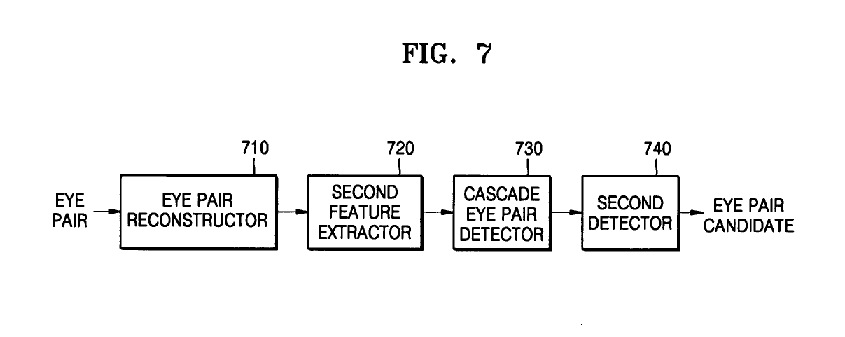

FIG. 7 illustrates a block diagram of the eye pair candidate detector 130 according to an embodiment of the present invention.

Referring to FIG. 7, the eye pair candidate detector 130 includes an eye pair reconstructor 710, a second feature extractor 720, a cascade eye pair detector 730, and a second detector 740.

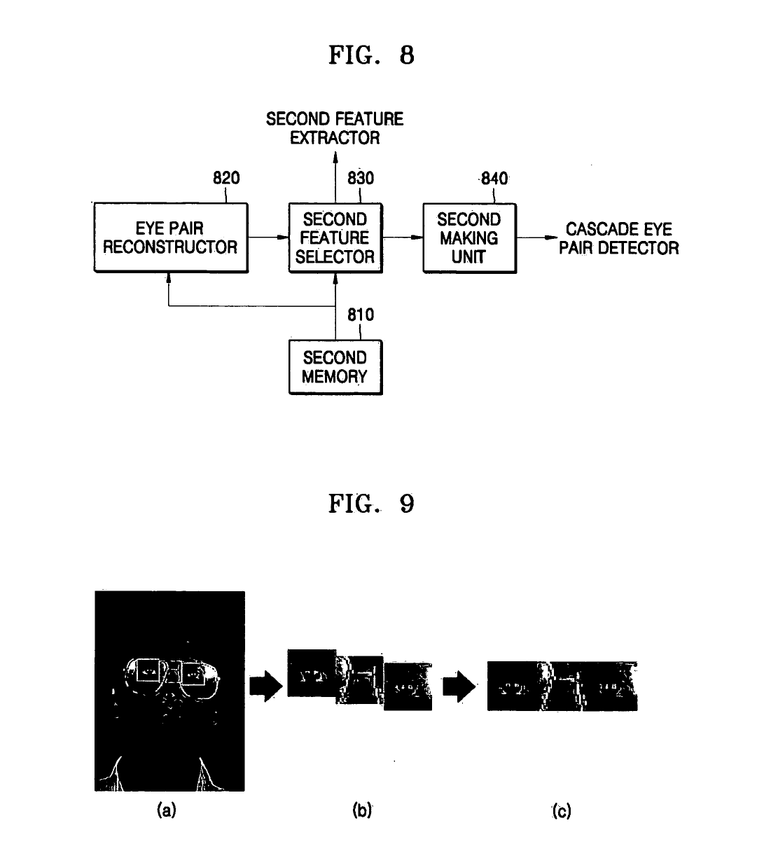

The second feature extractor 720 extracts an eye pair feature corresponding to an eye pair feature selected by an eye pair training device. The eye pair training device trains an eye pair training DB, and makes a cascade eye pair detector on the basis of eye pair features selected from the eye pair training result. The eye pair training device may be generated in an offline state and then used in the eye pair candidate detector 130. The eye pair training device will be described in detail later with reference to FIG. 8.

When the eye regions in both of the detected eye candidates are located at different heights, the eye pair reconstructor 710 preferably, though not necessarily, aligns the eye regions and a glabella region horizontally, and then provides the resulting eye pair image to the second feature extractor.

The cascade eye pair detector 730 detects whether the extracted eye pair feature from the cascade eye pair detector corresponds to the selected eye pair features. The cascade eye pair detector 730 has a cascade connection structure of a plurality of detectors to detect a combination of the selected eye pair features. The cascade eye pair detector 730 detects the extracted eye pair feature using the cascaded detectors.

The second detector 740 detects an eye pair which proceeds to the highest level of the cascade eye pair detector 730 as an eye pair candidate. The cascade eye pair detector 730 detects the extracted eye pair features using the cascaded detectors, and the second detector 740 detects an eye pair which reaches the highest level (that is, the most detectors) of the cascade eye pair detector 730 as an eye pair candidate. Since a combination of an eye pair which reaches the highest level (not the final level) of the cascade eye pair detector 730 is detected as an eye pair candidate, a number of eye pair candidates are detected by the cascade eye pair detector 730.

FIG. 8 illustrates a block diagram of an eye pair training device according to an embodiment of the present invention.

Referring to FIG. 8, the eye pair training device includes a second memory 810, an eye pair reconstructor 820, a second feature selector 830, and a second making unit 840.

The second memory 810 stores an eye pair training DB for a plurality of eye pair images, including both eye regions and a glabella region. When the eye regions and the glabella are located at different heights in the eye pair image, the eye pair reconstructor 710 aligns the eye regions and the glabella region horizontally, and then provides the resulting eye pair image to the second feature selector 830.

The second feature selector 830 trains the eye pair training DB by normalizing an eye pair image of the eye pair training DB to a predetermined size, and selects an eye pair feature to be extracted on the basis of the eye pair training result. Preferably, though not necessarily, the second feature selector 830 selects an eye pair feature through an appearance-based pattern recognition method. The appearance-based pattern recognition method recognizes an eye through templates trained by a training DB, such as the color, shape, and position of an eye. Preferably, though not necessarily, the second feature selector 830 is trained through an Adaboost algorithm.

Preferably, though not necessarily, the size of an eye pair image stored in the eye pair training DB is normalized to a fourth size with a width-to-height ratio of 3:1 (for example, 30×10 pixels).

The second making unit 840 makes a detector to detect an eye pair candidate from an eye pair generated through a combination of the eye candidates on the basis of the selected eye pair feature. Preferably, though not necessarily, the detector made by the second making unit 840 is a cascade detector having a cascade connection structure of detectors to detect a combination of features selected by the second feature selector 830.

FIG. 9 illustrates an eye pair image reconstructed by an eye pair reconstructor 710 or 820. FIG. 9(a) illustrates an example of a tilted face image, and FIG. 9(b) illustrates both eye candidates (that is, a left eye candidate and a right eye candidate) and a glabella region between the eye candidates, all of which are detected in the tilted face image. The eye candidates are located at different heights. FIG. 9(c) illustrates an eye pair image reconstructed from the eye candidates and the glabella region that were located at different heights. The second detector 740 or the second feature selector 830 must rotate the eye pair image to detect an eye pair candidate or to train the eye pair training DB.

For example, when the eye candidate detector 120 detects two right eye candidates and three left eye candidates, six eye pairs are generated through the combination of the five left and right eye candidates. To align the eyes in the eye pair, each of the six generated eye pairs must be rotated to the left or right, which requires an excessive amount of computation time. Accordingly, the eye pair reconstructor 710 divides the eye regions and the glabella region and then aligns the divided regions, thereby simply obtaining an aligned eye pair image.

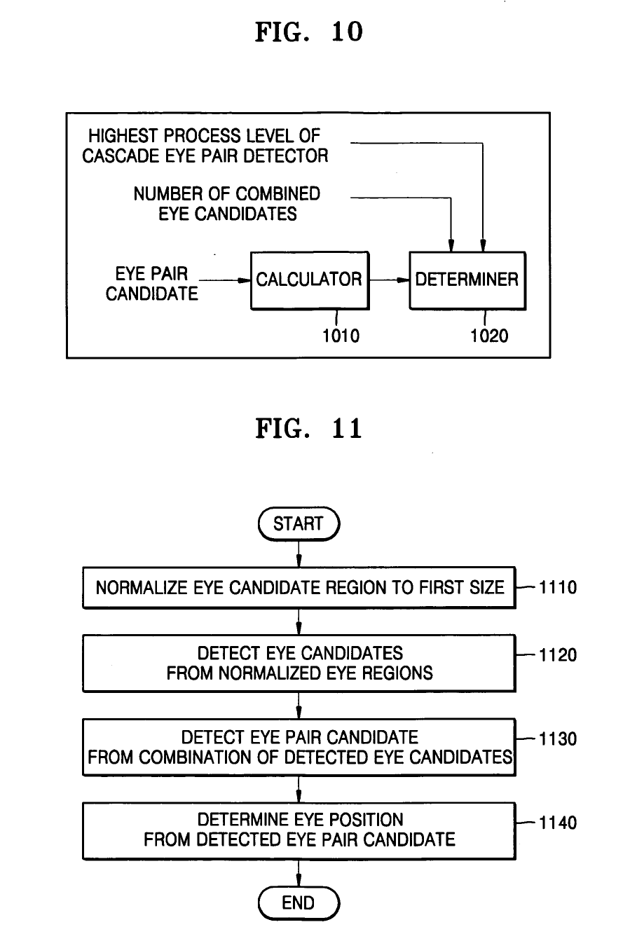

FIG. 10 is a block diagram illustrating an eye position determiner according to an embodiment of the present invention.

Referring to FIG. 10, the eye position determiner 140 includes a calculator 1010 and a determiner 1020. The calculator 1010 calculates the difference (c=dx+dy) between a left eye position (Lⁿₓ, Lⁿ_{y}) and a right eye position (Rⁿₓ, Rⁿ_{y}) in the eye pair candidate detected by the eye pair candidate detector 130. Here, “dx” and “dy” are respectively expressed by Equation 1 and Equation 2 below.

$$\begin{matrix}{d}_{x} = \vert \frac{{L}_{x}^{n} + {R}_{x}^{n}}{2} - 25 \vert & [ Equation 1 ] \\ {d}_{y} = \vert {R}_{y}^{n} - {L}_{y}^{n} \vert . & [ Equation 2 ]\end{matrix}$$

The determiner 1020 determines an eye pair candidate having the largest feature value “x” as an eye pair. The feature value “x” is generated on the basis of the highest level “a” of the cascade eye pair detector 730 for the detected eye pair candidate from the second detector 740, the number “b” of combined eye candidates from the combiner 350, and the position difference “c”. The feature value “x” is expressed by Equation 3 below.
x=a+b−c [Equation 3]

FIG. 11 is a flow chart illustrating an eye position detecting method according to an embodiment of the present invention.

Referring to FIG. 11, a left eye region and a right eye region are limited in a face image, and the limited left and right regions are normalized to the first size (for example, 50×50 pixels) (Operation 1110). The normalized eye regions are each divided into sub-windows of the second size that is smaller than the first size of 50×50 pixels and larger than 14×14 pixels.

The divided sub-window is normalized to the third size (for example, 14×14 pixels), an eye feature is selected through the training of the eye pair DB, and an eye candidate is detected by the cascade eye detector generated on the basis of the selected eye feature (Operation 1120). Preferably, though not necessarily, overlapping eye candidates are combined with each other.

An eye pair feature is selected through the training of the eye pair DB, and an eye pair candidate is detected by the cascade eye pair detector generated on the basis of the selected eye pair feature (Operation 1130).

One of the detected eye pair candidates is selected (Operation 1140). In Operation 1140, the feature value “x” is generated on the basis of the highest level “a” of the cascade eye pair detector for the detected eye pair candidate, the number “b” of combined eye candidates, and the position difference “c”, and then the eye pair candidate having the largest feature value “x” is selected as an eye pair.

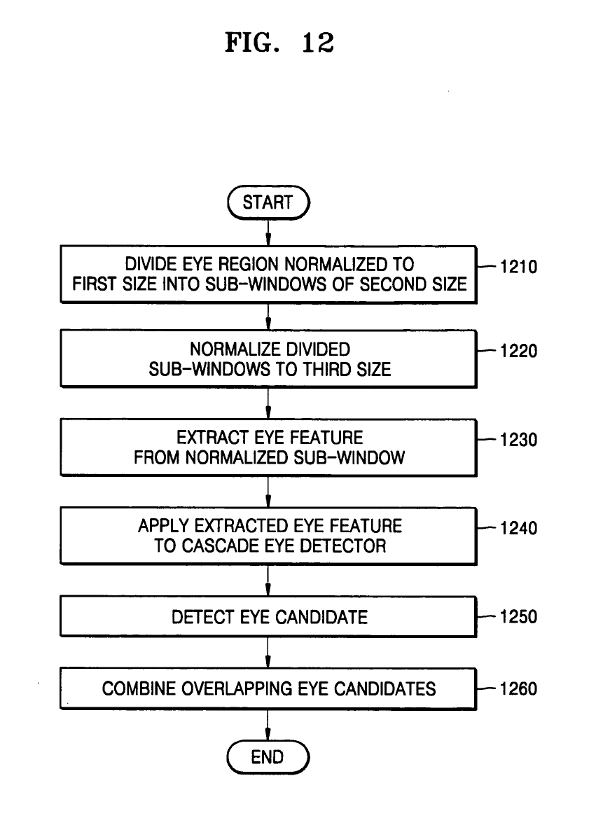

FIG. 12 is a flow chart illustrating the eye candidate detection operation (Operation 1120).

Referring to FIG. 12, when both eye regions which are normalized to the first size (for example, 50×50 pixels) are input, they are each divided into sub-windows of the second size (for example, larger than 14×14 pixels) (Operation 1210). The divided sub-windows are normalized to the third size (for example, 14×14 pixels) (Operation 1220). The size of the normalized eye region, the size of the sub-window, and the normalized sizes of the sub-window may vary according to the field to which the present invention is applied.

An eye feature selected by an eye training device, or an eye feature corresponding to a mirror feature, is extracted from the normalized sub-window (Operation 1230). The eye training device trains an eye training DB, and makes a cascade eye detector on the basis of eye features selected from the eye training result.

The extracted eye feature is applied to the cascade eye detector (Operation 1240), and the sub-window which reaches the highest level of the cascade eye detector is detected as an eye candidate (Operation 1250). The cascade eye detector has a cascade connection structure of a plurality of detectors used to detect a combination of the selected eye features, and detects the extracted eye features using the cascaded detectors. A sub-window corresponding to an eye feature which reaches the highest level (that is, the most detectors) of the cascade eye detector is detected as an eye candidate. Overlapping eye candidates are combined into one eye candidate having the average size and position of the eye candidates (Operation 1260).

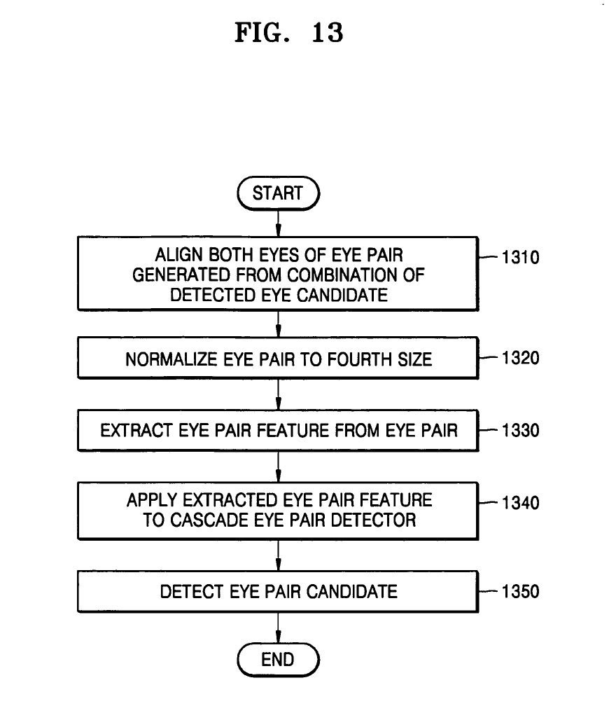

FIG. 13 is a flow chart illustrating an operation to detect an eye pair candidate from combinations of the detected eye candidates.

Referring to FIG. 13, when the eyes of an eye pair generated through a combination of detected eye candidates are positioned at different heights, the eye candidate regions and a glabella region are divided, and the divided regions are aligned, whereby an aligned eye pair image is simply obtained (Operation 1310). The obtained eye pair image is normalized to the fourth size (for example, 30×10 pixels) (Operation 1320).

An eye pair feature for each eye pair image is extracted on the basis of an eye pair feature selected by an eye pair training device (Operation 1330). The eye pair training device trains an eye pair training DB, and makes a cascade eye pair detector on the basis of eye pair features selected from the eye pair training result.

The extracted eye pair feature is applied to the cascade eye pair detector (Operation 1340), and an eye pair which reaches the highest level of the cascade eye pair detector is detected as an eye pair candidate (Operation 1350).

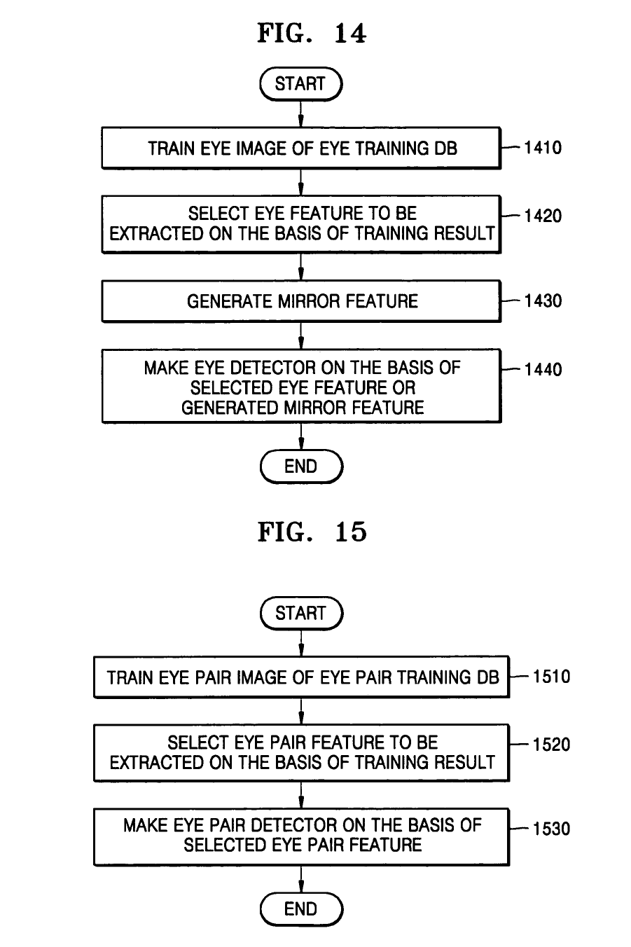

FIG. 14 is a flow chart illustrating an eye image training method according to an embodiment of the present invention.

Referring to FIG. 14, an eye image with a width-to-height ratio of 1:1 stored in the eye training DB is normalized to the third size (for example, 14×14 pixels), and the normalized eye image is trained (Operation 1410). An eye feature to be extracted from the eye training DB is selected on the basis of the eye training result (Operation 1420). The eye feature may be selected through an appearance-based pattern recognition method, preferably, though not necessarily, through an Adaboost algorithm. The extracted eye features are the color, shape, and position of an eye.

On the basis of a feature of the selected eye, a mirror feature corresponding to a feature of the other eye is generated (Operation 1430). An eye feature extracted through the training of only one eye, from one side of the face image, is selected. An eye feature for the eye on the other side is generated through a mirror feature of the already-selected eye feature. The mirror feature is a feature of the eye of the other side (for example, a right eye) generated by exchanging left and right coordinates of a feature of an eye of one side of the face image (for example, a left eye).

A detector to detect an eye from the eye image is made on the basis of the selected eye feature or the generated mirror feature (Operation 1440). Preferably, the detector is a cascade detector having a cascade connection structure of detectors used to detect a combination of the selected features.

FIG. 15 is a flow chart illustrating an eye pair training method according to an embodiment of the present invention.

Referring to FIG. 15, an eye pair image stored in the eye pair training DB is normalized to the fourth size with a width-to-height ratio of 3:1 (for example, 30×10 pixels), and the normalized eye pair image is trained (Operation 1510). An eye pair feature to be extracted from the eye pair training DB is selected on the basis of the eye pair training result (Operation 1520). The eye pair feature may be selected through an appearance-based pattern recognition method, preferably, though not necessarily, through an Adaboost algorithm. The extracted eye pair features are the color, shape, and position of an eye. A detector to detect an eye pair from the eye image is made on the basis of the selected eye pair feature (Operation 1530). Preferably, though not necessarily, the detector is a cascade detector having a cascade connection structure of detectors used to detect a combination of the selected features.

In addition to the above-described embodiments, the method of the present invention can also be implemented by executing computer readable code/instructions in/on a medium, e.g., a computer readable medium. The medium can correspond to any medium/media permitting the storing and/or transmission of the computer readable code. The code/instructions may form a computer program.

The computer readable code/instructions can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. The medium may also be a distributed network, so that the computer readable code/instructions is stored/transferred and executed in a distributed fashion. The computer readable code/instructions may be executed by one or more processors.

As stated above, the eye position detection apparatus and method according to the present invention may detect an eye position by using an eye feature and an eye pair feature extracted by training an eye training DB and an eye pair training DB through an Adaboost algorithm, thereby making it possible to accurately detect an eye image even when eyes are shut, illumination conditions change, or eyes are covered by glasses or hair.

Also, the eye position detection apparatus and method can be applied to a character industry adorning a human image in a camera phone with caps, glasses, and so on because it can accurately detect the eye position of the human image.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of detecting an eye position in a face image, the method comprising:
detecting eye candidates in eye regions normalized to a predetermined size from the face image;
detecting an eye pair candidate from the detected eye candidates; and
determining the eye position from the detected eye pair candidate.

2. The method of claim 1, further comprising normalizing a right eye region and a left eye region in the face image to a first size prior to detecting the eye candidates.

3. The method of claim 1, wherein detecting the eye candidates comprises:
dividing an eye region normalized to a first size into sub-windows of a second size which is smaller than the first size;
normalizing the sub-windows of the second size to a third size;
extracting an eye feature from the normalized sub-windows of the third size;
detecting sub-windows of the extracted eye feature as eye candidates by training a training DB which stores an eye image of the third size, and by using a cascade eye detector generated according to eye features selected from the eye image training result; and
combining overlapping eye candidates into an average size and position.

4. The method of claim 3, wherein a mirror feature is generated by exchanging left and right coordinates of the selected eye feature for a first eye, and the cascade eye detector is generated according to the mirror feature of a second eye.

5. The method of claim 3, wherein detecting the sub-windows as the eye candidates comprises:
determining whether the extracted eye feature accords with the selected eye features by applying the extracted eye feature to the cascade eye detector; and
detecting a sub-window of an eye feature which reaches a highest level of the cascade eye detector as one of the eye candidates.

6. The method of claim 3, wherein the eye region normalized to the first size is divided into the sub-windows of the second size while the second size is enlarged up to the first size by a predetermined factor.

7. The method of claim 3, wherein the eye image used in the eye image training DB is normalized to have a width-to-height ratio of 1:1.

8. The method of claim 1, wherein detecting the eye pair candidate from the detected eye candidates comprises:
generating an eye pair from combinations of the detected eye candidates, normalizing the generated eye pair to a predetermined size, and extracting an eye pair feature from the normalized eye pair; and
detecting the eye pair as the eye pair candidate by training an eye pair training DB, and by using a cascade eye pair detector generated according to eye pair features selected from the eye pair training result.

9. The method of claim 8, wherein detecting the eye pair as the eye pair candidate comprises:
determining whether the extracted eye pair feature accords with the selected eye pair features by applying the extracted eye pair feature to the cascade eye pair detector; and
detecting an eye pair which reaches a highest level of the cascade eye pair detector as the eye pair candidate.

10. The method of claim 8, further comprising, prior to extracting the eye pair feature, aligning the eye regions and a glabella region between the eye regions in response to the detected eye candidates being located at different heights.

11. The method of claim 8, wherein an eye pair image used in the eye pair training DB is normalized to have a width-to-height ratio of 3:1.

12. The method of claim 1, wherein the eye pair candidate having a largest feature value x is determined as an eye pair in determining the eye position from the detected eye pair candidate, x being expressed by
x=a+b−c;
wherein a is a highest process level number of a cascade eye pair detector for the detected eye pair candidate, b is a number of combined eye candidates, and c is a difference (dx+dy) between a left eye position (Lⁿₓ, Lⁿ_{y}) and a right eye position (Rⁿₓ, Rⁿ_{y});
dx and dy being respectively expressed by
$${d}_{x} = \vert \frac{{L}_{x}^{n} + {R}_{x}^{n}}{2} - 25 \vert$$
$${d}_{y} = \vert {R}_{y}^{n} - {L}_{y}^{n} \vert .$$

13. At least one computer readable medium storing instructions that control at least one processor to perform a method of detecting an eye position in a face image, the method comprising:
detecting eye candidates in eye regions normalized to a predetermined size from the face image;
detecting an eye pair candidate from the detected eye candidates; and
determining the eye position from the detected eye pair candidate.

14. A training method used to make a detector to detect an eye in an eye image, the method comprising:
training an eye image training DB by normalizing an eye image of the eye image training DB to a predetermined size;
selecting an eye feature to be extracted according to an eye image training result;
generating a mirror feature by exchanging left and right coordinates of the selected eye feature; and
making the detector according to the selected eye feature or the generated mirror feature.

15. The method of claim 14, wherein the eye image used in the eye image training DB is normalized to have a width-to-height ratio of 1:1.

16. The method of claim 14, wherein the detector is a cascade detector having a cascade connection structure of detectors used to detect combinations of a plurality of eye features extracted from the eye image training result.

17. A training method used to make a detector to detect an eye pair in an eye pair image, the method comprising:
training an eye pair training DB by normalizing an eye pair image of the eye pair training DB to a predetermined size;
selecting an eye pair feature to be extracted according to an eye pair image training result; and
making the detector according to the selected eye pair feature,
wherein the eye pair image used in the eye pair training DB is normalized to have a width-to-height ratio of 3:1.

18. The method of claim 17, further comprising, prior to training the eye pair training DB, dividing an eye pair image of a tilted face image into eye regions and a glabella region, and aligning the eye regions and the glabella region.

19. An apparatus to detect an eye position in a face image, the apparatus comprising:
an eye candidate detector which detects eye candidates in eye regions normalized to a predetermined size from the face image;
an eye pair candidate detector which detects an eye pair candidate from the detected eye candidates; and
an eye position determiner which determines the eye position from the detected eye pair candidate.

20. The apparatus of claim 19, further comprising an eye region limiter which limits and normalizes a right eye region and a left eye region in the face image to a first size.

21. The apparatus of claim 19, wherein the eye candidate detector comprises:
a region divider which divides an eye region normalized to a first size into sub-windows of a second size which is smaller than the first size;
a normalizer which normalizes the sub-windows of the second size to a third size;
a feature extractor which extracts an eye feature from the normalized sub-windows of the third size;
a cascade eye detector which trains an eye image training DB, selects eye features from the eye image training result, and detects whether the extracted eye feature accords with the selected eye features;
a detector which detects a sub-window of an eye feature which reaches a highest level of the cascade eye detector as an eye candidate; and
a combiner which combines overlapping eye candidates into an average size and position.

22. The apparatus of claim 21, wherein the cascade eye detector generates mirror features by exchanging left and right coordinates of the selected eye feature, and detects whether the extracted eye feature accords with the generated mirror features.

23. The apparatus of claim 21, wherein the eye image used in the eye image training DB is normalized to have a width-to-height ratio of 1:1

24. The apparatus of claim 21, wherein the cascade eye detector has a cascade connection structure of detectors used to detect combinations of a plurality of eye features extracted from the eye image training result.

25. The apparatus of claim 21, wherein the region divider divides the eye region by enlarging the second size of the sub-window up to the first size of the eye region by a predetermined factor.

26. The apparatus of claim 19, wherein the eye pair candidate detector comprises:
a feature extractor which extracts an eye pair feature from an eye pair generated from combinations of the detected eye candidates;
a cascade eye pair detector which trains an eye pair training DB, selects eye pair features from the eye pair training result, and detects whether the extracted eye pair feature accords with the selected eye pair features; and
a detector which detects a combination of an eye pair which reaches the highest level of the cascade eye pair detector as an eye pair candidate.

27. The apparatus of claim 26, wherein the eye pair candidate detector further comprises an eye pair reconstructor which aligns the eye regions and a glabella region between the eye regions in response to the detected eye candidates being located at different heights.

28. The apparatus of claim 26, wherein the cascade eye pair detector has a cascade connection structure of detectors used to detect combinations of a plurality of eye pair features extracted from the eye pair training result.

29. The apparatus of claim 26, wherein the eye pair image used in the eye pair training DB is normalized to have a width-to-height ratio of 3:1.

30. The apparatus of claim 19, wherein the eye position determiner comprises:
a calculator which calculates a position difference between a left eye and a right eye of the detected eye pair candidate; and
a determiner which determines an eye pair according to a highest process level number of a cascade eye pair detector for the detected eye pair candidate, a number of combined eye candidates, and a calculated position difference.

31. The apparatus of claim 30, wherein the determiner determines an eye pair candidate of a highest feature value x among the detected eye pair candidates as an eye pair, x being expressed by
x=a+b−c;
wherein a is the highest process level number of the cascade detector for the detected eye pair candidate, b is the number of combined eye candidates, and c is a difference (dx+dy) between a left eye position (Lⁿₓ, Lⁿ_{y}) and a right eye position (Rⁿₓ, Rⁿ_{y});
dx and dy being respectively expressed by
$${d}_{x} = \vert \frac{{L}_{x}^{n} + {R}_{x}^{n}}{2} - 25 \vert$$
$${d}_{y} = \vert {R}_{y}^{n} - {L}_{y}^{n} \vert .$$

32. A training device to make a detector to detect an eye in an eye image, the device comprising:
a memory which stores an eye image training DB;
a feature selector which trains the eye image training DB by normalizing an eye image of the eye image training DB to a predetermined size, and selects an eye feature to be extracted according to the eye image training result;
a mirror feature generator which generates a mirror feature by exchanging left and right coordinates of the selected eye feature; and
a making unit which makes the detector according to the selected eye feature or the generated mirror feature.

33. The device of claim 32, wherein the eye image used in the eye image training DB is normalized to have a width-to-height ratio of 1:1.

34. The device of claim 32, wherein the making unit makes a cascade detector having a cascade connection structure of detectors to detect combinations of a plurality of eye features selected from the eye image training result.

35. A training device to make a detector to detect an eye pair in an eye pair image, the device comprising:
a memory which stores an eye pair training DB;
a feature selector which trains the eye image training DB by normalizing an eye pair image of the eye pair training DB to a predetermined size, and selects an eye pair feature to be extracted according to the eye pair training result; and
a making unit which makes the detector according to the selected eye pair feature,
wherein the eye pair image used in the eye pair training DB is normalized to have a width-to-height ratio of 3:1.

36. The device of claim 35, further comprising a reconstructor which divides an eye pair image of a tilted face image into eye regions and a glabella region, and aligns the eye regions and the glabella region.

37. At least one computer readable medium storing instructions that control at least one processor to perform a training method used to make a detector to detect an eye in an eye image, the method comprising:
training an eye image training DB by normalizing an eye image of the eye image training DB to a predetermined size;
selecting an eye feature to be extracted according to an eye image training result;
generating a mirror feature by exchanging left and right coordinates of the selected eye feature; and
making the detector according to the selected eye feature or the generated mirror feature.

38. At least one computer readable medium storing instructions that control at least one processor to perform a training method used to make a detector to detect an eye pair in an eye pair image, the method comprising:
training an eye pair training DB by normalizing an eye pair image of the eye pair training DB to a predetermined size;
selecting an eye pair feature to be extracted according to an eye pair image training result; and
making the detector according to the selected eye pair feature,
wherein the eye pair image used in the eye pair training DB is normalized to have a width-to-height ratio of 3:1.

39. A method of making a detector to detect an eye in an eye image, the method comprising:
training an eye image training DB by normalizing the eye image to a predetermined size;
selecting an eye feature to be extracted according to the eye image training; and
making the detector according to the selected eye feature.

40. A method of making a detector to detect an eye pair in an eye pair image, the method comprising:
training an eye pair training DB by normalizing the eye pair image to a predetermined size;
selecting an eye pair feature to be extracted according to the eye pair training; and
making the detector according to the selected eye pair feature.

41. A method of making a detector to detect an eye in an eye image, the method comprising:
selecting an eye feature to be extracted from the eye image;
generating a mirror feature by exchanging left and right coordinates of the selected eye feature; and
making the detector according to the generated mirror feature.
